(19) United States
(12) Patent Application Publication
(10) Pub. No.: US 2003/0084319 A1
(43) Pub. Date: May 1, 2003

(54) Node, method and computer readable medium for inserting an intrusion prevention system into a network stack

(76) Inventors: Richard Paul Tarquini, Apex, NC (US); Richard Louis Schertz, Raleigh, NC (US); George Simon Gales, Plano, TX (US)

Correspondence Address: HEWLETT-PACKARD COMPANY, Intellectual Property Administration, P.O. Box 272400, Fort Collins, CO, 80527-2400, US

(21) Appl. No.: 10/001,445

(22) Filed: Oct. 31, 2001

(51) Int. Cl. G06F 11/30

(52) U.S. Cl. 713/200

(57) ABSTRACT

A node of a network running an intrusion detection system, the node comprising a central processing unit, a memory module for storing data in machine readable format for retrieval and execution by the central processing unit, a database for storing a plurality of machine-readable network-exploit signatures, an operating system comprising a network stack comprising a protocol driver, a media access control driver and an instance of the intrusion detection system implemented as an intermediate driver and bound to the protocol driver and the media access control driver is provided. A method of filtering data at a node of a network comprising binding an intrusion prevention system directly to a media access control driver of a network stack of a node of the network is provided. A computer-readable medium having stored thereon a plurality of instructions, including a set of instructions for filtering network data, to be executed, said set of instructions, when executed by a processor, cause said processor to perform a computer method of binding an intrusion prevention system with a media access control driver upon initialization of an operating system of the computer is provided.

### CROSS-REFERENCE TO RELATED APPLICATIONS

This patent application is related to co-pending U.S. patent application Ser. No. ______, entitled “METHOD AND COMPUTER READABLE MEDIUM FOR SUPPRESSING EXECUTION OF SIGNATURE FILE DIRECTIVES DURING A NETWORK EXPLOIT,” filed Oct. 31, 2001, co-assigned herewith; U.S. patent application Ser. No. ______, entitled “SYSTEM AND METHOD OF DEFINING THE SECURITY CONDITION OF A COMPUTER SYSTEM,” filed Oct. 31, 2001, co-assigned herewith; U.S. patent application Ser. No. ______, entitled “SYSTEM AND METHOD OF DEFINING THE SECURITY VULNERABILITIES OF A COMPUTER SYSTEM,” filed Oct. 31, 2001, co-assigned herewith; U.S. patent application Ser. No. ______, entitled “SYSTEM AND METHOD OF DEFINING UNAUTHORIZED INTRUSIONS ON A COMPUTER SYSTEM,” filed Oct. 31, 2001, co-assigned herewith; U.S. patent application Ser. No. ______, entitled “NETWORK INTRUSION DETECTION SYSTEM AND METHOD,” filed Oct. 31, 2001, co-assigned herewith; U.S. patent application Ser. No. ______, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO,” filed Oct. 31, 2001, co-assigned herewith; U.S. patent application Ser. No. ______, entitled “NETWORK, METHOD AND COMPUTER READABLE MEDIUM FOR DISTRIBUTED SECURITY UPDATES TO SELECT NODES ON A NETWORK,” filed Oct. 31, 2001, co-assigned herewith; U.S. patent application Ser. No. ______, entitled “METHOD, COMPUTER READABLE MEDIUM, AND NODE FOR A THREE-LAYERED INTRUSION PREVENTION SYSTEM FOR DETECTING NETWORK EXPLOITS,” filed Oct. 31, 2001, co-assigned herewith; U.S. patent application Ser. No. ______, entitled “SYSTEM AND METHOD OF AN OS-INTEGRATED INTRUSION DETECTION AND ANTI-VIRUS SYSTEM,” filed Oct. 31, 2001, co-assigned herewith; U.S. patent application Ser. No. ______, entitled “METHOD, NODE AND COMPUTER READABLE MEDIUM FOR IDENTIFYING DATA IN A NETWORK EXPLOIT,” filed Oct. 31, 2001, co-assigned herewith; U.S. patent application Ser. No. ______, entitled “NODE, METHOD AND COMPUTER READABLE MEDIUM FOR OPTIMIZING PERFORMANCE OF SIGNATURE RULE MATCHING IN A NETWORK,” filed Oct. 31, 2001, co-assigned herewith; U.S. patent application Ser. No. ______, entitled “METHOD, NODE AND COMPUTER READABLE MEDIUM FOR PERFORMING MULTIPLE SIGNATURE MATCHING IN AN INTRUSION PREVENTION SYSTEM,” filed Oct. 31, 2001, co-assigned herewith; U.S. patent application Ser. No. ______, entitled “USER INTERFACE FOR PRESENTING DATA FOR AN INTRUSION PROTECTION SYSTEM,” filed Oct. 31, 2001, co-assigned herewith; U.S. patent application Ser. No. ______, entitled “NODE AND MOBILE DEVICE FOR A MOBILE TELECOMMUNICATIONS NETWORK PROVIDING INTRUSION DETECTION,” filed Oct. 31, 2001, co-assigned herewith; U.S. patent application Ser. No. ______, entitled “METHOD AND COMPUTER-READABLE MEDIUM FOR INTEGRATING A DECODE ENGINE WITH AN INTRUSION DETECTION SYSTEM,” filed Oct. 31, 2001, co-assigned herewith; U.S. patent application Ser. No. ______, entitled “SYSTEM AND METHOD OF GRAPHICALLY DISPLAYING DATA FOR AN INTRUSION PROTECTION SYSTEM,” filed Oct. 31, 2001, co-assigned herewith; and U.S. patent application Ser. No. ______, entitled “SYSTEM AND METHOD OF GRAPHICALLY CORRELATING DATA FOR AN INTRUSION PROTECTION SYSTEM,” filed Oct. 31, 2001, co-assigned herewith.

### TECHNICAL FIELD OF THE INVENTION

This invention relates to network technologies, and more particularly, to a node, method and computer readable medium for inserting an intrusion prevention system into the network.

### BACKGROUND OF THE INVENTION

Network-exploit attack tools, such as denial-of-service (DoS) attack utilities, are becoming increasing sophisticated and, due to evolving technologies, simple to execute. Relatively unsophisticated attackers can arrange, or be involved in, computer system compromises directed at one or more targeted facilities. A network system attack (also referred to herein as an intrusion) is an unauthorized or malicious use of a computer or computer network and may involve hundred or thousands of unprotected, or alternatively compromised, Internet nodes together in a coordinated attack on one or more selected targets.

Network attack tools based on the client/server model have become a preferred mechanism for executing network attacks on targeted networks or devices. High capacity machines in networks having deficient security are often desired by attackers to launch distributed attacks therefrom. University servers typically feature high connectivity and capacity but relatively mediocre security. Such networks also often have inexperienced or overworked network administrators making them even more vulnerable for involvement in network attacks.

Network-exploit attack tools, comprising hostile attack applications such as denial-of-service utilities, responsible for transmitting data across a network medium will often have a distinctive “signature,” or recognizable pattern within the transmitted data. The signature may comprise a recognizable sequence of particular packets and/or recognizable data that is contained within one or more packets. Signature analysis is often performed by a network intrusion prevention system (IPS) and may be implemented as a pattern-matching algorithm and may comprise other signature recognition capabilities as well as higher-level application monitoring utilities. A simple signature analysis algorithm may search for a particular string that has been identified as associated with a hostile application. Once the string is identified within a network data stream, the one or more packets carrying the string may be identified as “hostile,” or exploitative, and the IPS may then perform any one or more of a number of actions, such as logging the identification of the frame, performing a countermeasure, or performing another data archiving or protection measure.

Intrusion prevention systems (IPS) encompass technology that attempts to identify exploits against a computer system or network of computer systems. Numerous types of IPSs exist and each are generally classified as either a network-based, host-based, or node-based IPS.

Network-based IPS appliances are typically dedicated systems placed at strategic places on a network to examine data packets to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPS appliances examine the contents of data packets by parsing network frames and packets and analyzing individual packets based on the protocols used on the network. A network-based IPS appliance inconspicuously monitors network traffic inconspicuously, i.e., other network nodes may be, and often are, unaware of the presence of the network-based IPS appliance. Passive monitoring is normally performed by a network-based IPS appliance by implementation of a “promiscuous mode” access of a network interface device. A network interface device operating in promiscuous mode copies packets directly from the network media, such as a coaxial cable, 100baseT or other transmission medium, regardless of the destination node to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, i.e., a packet that has attributes corresponding to a known attack signature monitored for occurrence by the network-based IPS appliance, an alert may be generated thereby and transmitted to a management module of the IPS so that a networking expert may implement security measures. Network-based IPS appliances have the additional advantage of operating in real-time and thus can detect an attack as it is occurring.

However, network-based IPS appliances may often generate a large number of “false positives,” i.e., incorrect diagnoses of an attack. False positive diagnoses by network-based IPS appliances result, in part, due to errors generated during passive analysis of all the network traffic captured by the IPS that may be encrypted and formatted in any number of network supported protocols. Content scanning by a network-based IPS is not possible on an encrypted link although signature analysis based on protocol headers may be performed regardless of whether the link is encrypted or not. Additionally, network-based IPS appliances are often ineffective in high speed networks. As high speed networks become more commonplace, software-based network-based IPS appliances that attempt to sniff all packets on a link will become less reliable. Most critically, network-based IPS appliances can not prevent attacks unless integrated with, and operated in conjunction with, a firewall protection system.

Host-based IPSs detect intrusions by monitoring application layer data. Host-based IPSs employ intelligent agents to continuously review computer audit logs for suspicious activity and compare each change in the logs to a library of attack signatures or user profiles. Host-based IPSs may also poll key system files and executable files for unexpected changes. Host-based IPSs are referred to as such because the IPS utilities reside on the system to which they are assigned to protect. Host-based IPSs typically employ application-level monitoring techniques that examine application logs maintained by various applications. For example, a host-based IPS may monitor a database engine that logs failed access attempts and/or modifications to system configurations. Alerts may be provided to a management node upon identification of events read from the database log that have been identified as suspicious. Host-based IPSs, in general, generate very few false-positives. However, host-based IPS such as log-watchers are generally limited to identifying intrusions that have already taken place and are also limited to events occurring on the single host. Because log-watchers rely on monitoring of application logs, any damage resulting from the logged attack will generally have taken place by the time the attack has been identified by the IPS. Some host-based IPSs may perform intrusion-preventative functions such as ‘hooking’ or ‘intercepting’ operating system application programming interfaces to facilitate execution of preventative operations by an IPS based on application layer activity that appears to be intrusion-related. Because an intrusion detected in this manner has already bypassed any lower level IPS, a host-based IPS represents a last layer of defense against network exploits. However, host-based IPSs are of little use for detecting low-level network events such as protocol events.

Node-based IPSs apply the intrusion detection and/or prevention technology on the system being protected. An example of node-based IPS technologies is inline intrusion detection. A node-based IPS may be implemented at each node of the network that is desired to be protected. Inline IPSs comprise intrusion detection technologies embedded in the protocol stack of the protected network node. Because the inline IPS is embedded within the protocol stack, both inbound and outbound data will pass through, and be subject to monitoring by, the inline IPS. An inline IPS overcomes many of the inherent weaknesses of network-based solutions. As mentioned hereinabove, network-based solutions are generally ineffective when monitoring high-speed networks due to the fact that network-based solutions attempt to monitor all network traffic on a given link. Inline intrusion prevention systems, however, only monitor traffic directed to the node on which the inline IPS is installed. Thus, attack packets can not physically bypass an inline IPS on a targeted machine because the packet must pass through the protocol stack of the targeted device. Any bypassing of an inline IPS by an attack packet must be done entirely by ‘logically’ bypassing the IPS, i.e., an attack packet that evades an inline IPS must do so in a manner that causes the inline IPS to fail to identify, or improperly identify, the attack packet. Additionally, inline IPSs provide the hosting node with low-level monitoring and detection capabilities similar to that of a network IPS and may provide protocol analysis and signature matching or other low-level monitoring or filtering of host traffic. The most significant advantage offered by inline IPS technologies is that attacks are detected as they occur. Whereas host-based IPSs determine attacks by monitoring system logs, inline intrusion detection involves monitoring network traffic and isolating those packets that are determined to be part of an attack against the hosting server and thus enabling the inline IPS to actually prevent the attack from succeeding. When a packet is determine to be part of an attack, the inline IPS layer may discard the packet thus preventing the packet from reaching the upper layer of the protocol stack where damage may be caused by the attack packet—an effect that essentially creates a local firewall for the server hosting the inline IPS and protecting it from threats coming either from an external network, such as the Internet, or from within the network. Furthermore, the inline IPS layer may be embedded within the protocol stack at a layer where packets have been unencrypted so that the inline IPS is effective operating on a network with encrypted links. Additionally, inline IPSs can monitor outgoing traffic because both inbound and outbound traffic respectively destined to and originating from a server hosting the inline IPS must pass through the protocol stack.

Although the advantages of inline IPS technologies are numerous, there are drawbacks to implementing such a system. Inline intrusion detection is generally processor intensive and may adversely effect the node's performance hosting the detection utility. Additionally, inline IPSs may generate numerous false positive attack diagnoses. Furthermore, inline IPSs cannot detect systematic probing of a network, such as performed by reconnaissance attack utilities, because only traffic at the local server hosting the inline IPS is monitored thereby.

Each of network-based, host-based and inline-based IPS technologies have respective advantages as described above. Ideally, an intrusion prevention system will incorporate all of the aforementioned intrusion detection strategies. Additionally, an IPS may comprise one or more event generation mechanisms that report identifiable events to one or more management facilities. An event may comprise an identifiable series of system or network conditions or it may comprise a single identified condition. An IPS may also comprise an analysis mechanism or module and may analyze events generated by the one or more event generation mechanisms. A storage module may be comprised within an IPS for storing data associated with intrusion-related events. A countermeasure mechanism may also be comprised within the IPS for executing an action intended to thwart, or negate, a detected exploit.

IPSs are often susceptible to a type of attack commonly referred to as a “polymorphic attack.” Polymorphic attacks create abnormal or malicious streams of network traffic to obscure the attack from the IPS system. Polymorphic attacks generally take one of two forms: an insertion attack or an evasion attack. An insertion attack involves sending extra data to the IPS system which the host under attack will not accept. Content scanners are often evaded in this manner. An evasion attack causes an IPS system to drop data by any number of methods that may include generating fragmentation errors, time-to-live (TTL) manipulation and/or other protocol distorting techniques. Both evasion and insertion attacks, and polymorphic attacks in general, share the common characteristic that an IPS can be “tricked” into incorrectly evaluating the behavioral response of a network stack in response to suspect data received thereby. Accordingly, an attack can be directed at a targeted node without knowledge thereof by the IPS thus circumventing security procedures that may be executed by the network-based IPS and enabling an attacker to exploit security weaknesses of the targeted node.

### SUMMARY OF THE INVENTION

In accordance with an embodiment of the present invention, a node of a network running an intrusion detection system, the node comprising a central processing unit, a memory module for storing data in machine readable format for retrieval and execution by the central processing unit, a database for storing a plurality of machine-readable network-exploit signatures, an operating system comprising a network stack comprising a protocol driver, a media access control driver and an instance of the intrusion detection system implemented as an intermediate driver and bound to the protocol driver and the media access control driver is provided. In accordance with another embodiment of the present invention, a method of filtering data at a node of a network comprising binding an intrusion prevention system directly to a media access control driver of a network stack of a node of the network is provided. In accordance with yet another embodiment of the present invention, a computer-readable medium having stored thereon a plurality of instructions, including a set of instructions for filtering network data, to be executed, said set of instructions, when executed by a processor, cause said processor to perform a computer method of binding an intrusion prevention system with a media access control driver upon initialization of an operating system of the computer is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an exemplary arrangement for executing a computer system compromise according to the prior art;

FIG. 2 illustrates a comprehensive intrusion prevention system employing network-based and hybrid host-based and node based intrusion detection technologies according to an embodiment of the invention;

FIG. 3 is an exemplary network stack according to the prior art;

FIG. 4 illustrates a network node that may run an instance of an intrusion protection system application according to an embodiment of the present invention;

FIG. 5 illustrates an exemplary network node that may operate as a management node within a network protected by the intrusion protection system according to an embodiment of the present invention;

FIG. 6 illustrates an exemplary network stack having an intrusion protection system inserted therein at the network layer for preventing polymorphic attacks according to an embodiment of the present invention.

### DETAILED DESCRIPTION OF THE DRAWINGS

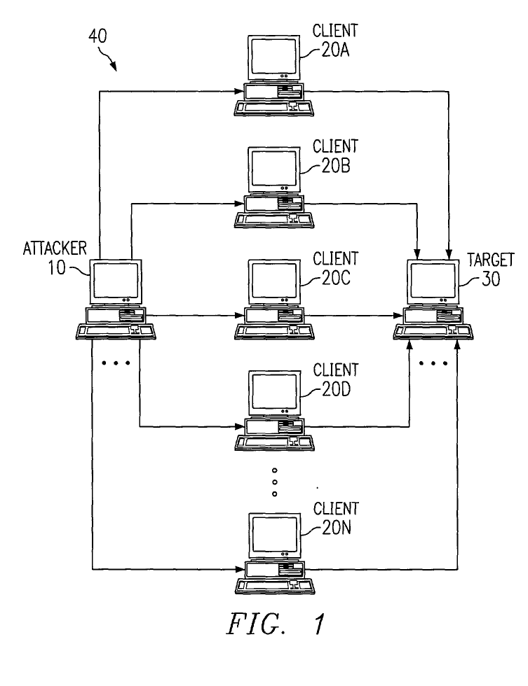

The preferred embodiment of the present invention and its advantages are best understood by referring to FIGS. 1 through 6 of the drawings, like numerals being used for like and corresponding parts of the various drawings.

In FIG. 1, there is illustrated an exemplary arrangement for executing a computer system compromise—the illustrated example showing a simplified distributed intrusion network 40 arrangement typical of distributed system attacks directed at a target 30 machine. An attack 10 machine may direct execution of a distributed attack by any number of attacker attack agents 20A-20N by one of numerous techniques such as remote control by IRC “robot” applications. Attack agents 20A-20N, also referred to as “zombies” and “attack agents,” are generally computers that are available for public use or that have been compromised such that a distributed attack may be launched upon command of an attack 10 machine. Numerous types of distributed attacks may be launched against a target 30 machine. The target 30 machine may suffer extensive damage from simultaneous attack of attack agents 20A-20N and the attack agents 20A-20N may be damaged from the client attack application as well. A distributed intrusion network may include an additional layer of machines involved in an attack intermediate the attack 10 machine and attack agents 20A-20N. These intermediate machines are commonly referred to as “handlers” and each handler may control one or more attack agents 20A-20N. The arrangement shown for executing a computer system compromise is illustrative only and may compromise numerous arrangements that are as simple as a single attack 10 machine attacking a target 30 machine by, for example, sending malicious probe packets or other data intended to compromise target 30 machine. Target machine may be, and often is, connected to a larger network and access thereto by attack 10 machine may cause damage to a large collection of computer systems commonly located within the network.

One or more of three general techniques are typically implemented to protect a system that may be targeted in a computer system compromise: network-based intrusion prevention systems, host-based intrusion prevention systems and node-based intrusion prevention systems as described hereinabove. Network-based IPS appliances are typically IPS dedicated components placed at strategic positions on a network to examine network frames in an attempt to determine if they coincide with known attack signatures. To compare packets with known attack signatures, network-based IPS appliances utilize a mechanism referred to as passive protocol analysis to inconspicuously monitor, or “sniff,” all traffic on a network and to detect low-level events that may be discerned from raw network traffic. Network exploits may be detected by identifying patterns or other observable characteristics of network frames. Network-based IPSs examine the contents of data packets by parsing network frames and packets and analyzing individual packets based on the protocols used on the network. A network-based IPS appliance typically monitors network traffic inconspicuously, that is other network nodes may be, and often are, unaware of the presence of the network-based IPS appliance. Passive monitoring is normally performed by a network-based IPS appliance by implementation of a ‘promiscuous mode’ access of a network interface device. A network interface device operating in promiscuous mode copies packets directly from the network media, such as a coaxial cable, 100baseT or other transmission medium, regardless of the destination device to which the packet is addressed. Accordingly, there is no simple method for transmitting data across the network transmission medium without the network-based IPS appliance examining it and thus the network-based IPS appliance may capture and analyze all network traffic to which it is exposed. Upon identification of a suspicious packet, that is a packet that has attributes corresponding to a known attack signature monitored for occurrence by the network-based IPS appliance, an alert may be generated by the network-based IPS appliance and transmitted to a management node of the IPS where security measures may be executed or a networking expert may perform a security action. Network-based IPS appliances have the additional advantage of operating in real-time and thus may detect attacks as the attack is occurring and, dependent upon the placement of the network-based IPS appliance, may prevent the attack from reaching the targeted node. Network-based intrusion prevention system appliances attempt to detect attacks originating from an external network, such as the Internet, by analyzing data inbound for the network and may be co-located with a network firewall. Network frames may be collected and compared against a database of various attack signatures. An alert may be generated and transmitted to a management node that performs a corrective action and/or that informs a network administrator of the detected attack whom may then take a corrective action such as closing a communication port of a firewall or performing another security procedure. Automated security measures may also be executed upon detection of an attack by a network-based IPS appliance if the appliance is integrated, or operating in conjunction, with a firewall. Typically, network-based intrusion prevention system appliances are placed at, or near, the boundary of the network being protected. Moreover, a network-based IPS appliance is ideal for implementation of a state-based IPS security measure that requires accumulation and storage of identified suspicious packets of attacks that may not be identified “atomically,” that is by a single network packet. For example, TCP SYN flood attacks are not identifiable by a single TCP SYN packet but rather are generally identified by accumulating a count of TCP SYN packets that exceed a predefined threshold over a defined period of time. A network-based IPS appliance is therefore an ideal platform for implementing state-based signature detection because the network-based IPS appliance may collect all such TCP SYN packets that pass over the local network media and thus may properly archive and analyze the frequency of such events.

Host-based intrusion prevention systems, also referred to as “log watchers,” detect intrusions by monitoring system logs. Generally, host-based intrusion systems reside on the system intended to be protected. Host-based intrusion prevention systems may detect intrusions at the application level, such as analysis of database engine access attempts and changes to system configurations.

Node based intrusion prevention systems involve monitoring network activity to a specific node on the network from any other node by analysis of frames received thereby that may be involved in an attack. The IPS system of the present invention preferably utilizes a hybrid IPS of inline node-based intrusion detection and host-based intrusion detection at each node of a network protected by the IPS.

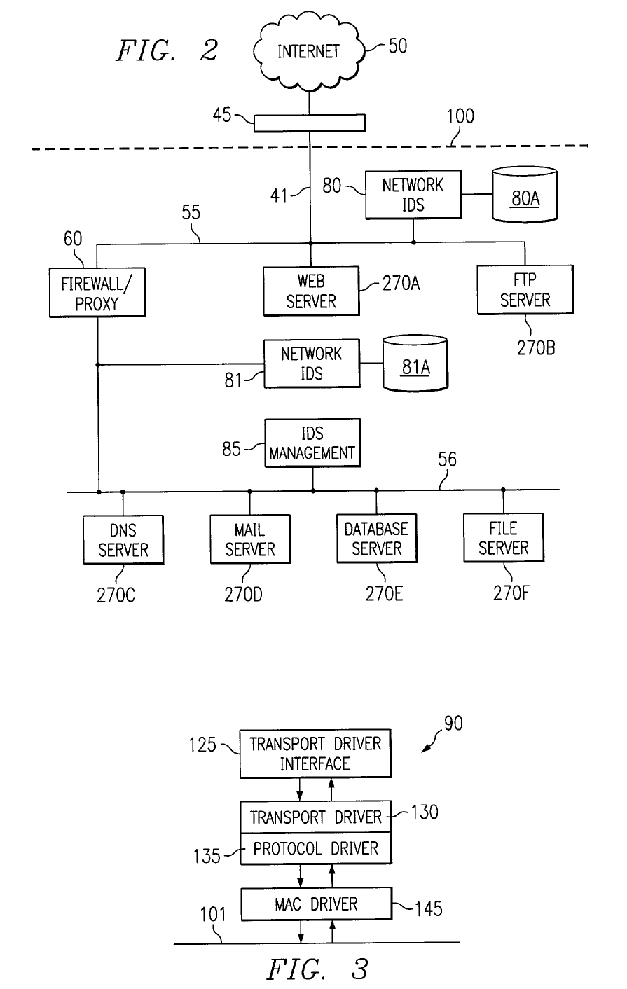

In FIG. 2, there is illustrated a comprehensive intrusion prevention system employing network-based and hybrid host-based and node based intrusion detection technologies according to an embodiment of the invention. One or more networks 100 may interface with the Internet 50 via a router 45 or other device. In the illustrative example, two Ethernet networks 55 and 56 are included in network 100. Ethernet network 55 includes a web-content server 270A and a file transport protocol-content server 270B. Ethernet network 56 includes a domain name server 270C, a mail server 270D, a database sever 270E and a file server 270F. A firewall/proxy router 60 disposed intermediate Ethernets 55 and 56 provides security and address resolution to the various systems of network 56. A network-based IPS appliance 80 and 81 is respectively implemented on both sides of firewall/proxy router 60 to facilitate monitoring of attempted attacks against one or more elements of Ethernets 55 and 56 and to facilitate recording successful attacks that successfully penetrate firewall/proxy router 60. Network-based IPS appliances 80 and 81 may respectively include (or alternatively be connected to) a database 80A and 81A of known attack signatures, or rules, against which network frames captured thereby may be compared. Alternatively, a single database (not shown) may be centrally located within network 100 and may be accessed by network-based IPS appliances 80 and 81. Accordingly, network-based IPS appliance 80 may monitor all packets inbound from Internet 50 to network 100 arriving at Ethernet network 55. Similarly, a network-based IPS appliance 81 may monitor and compare all packets passed by firewall/proxy router 60 for delivery to Ethernet network 56. An IPS management node 85 may also be included in network 100 to facilitate configuration and management of the IPS components included in network 100. In view of the abovenoted deficiencies of network-based intrusion prevention systems, a hybrid host-based and node-based intrusion prevention system is preferably implemented within each of the various nodes, such as servers 270A-270N (also referred to herein as “nodes”), of Ethernet networks 55 and 56 in the secured network 100. Management node 85 may receive alerts from respective nodes within network 100 upon detection of an intrusion event by any one of the network-based IPS appliances 80 and 81 as well as any of the nodes of network 100 having a hybrid agent-based and node-based IPS implemented thereon. Additionally, each node 270A-270F may respectively employ a local file system for archiving intrusion-related events, generating intrusion-related reports, and storing signature files to which local network frames and/or packets are examined against.

Preferably, network-based IPS appliances 80 and 81 are dedicated entities for monitoring network traffic on associated Ethernets 55 and 56 of network 100. To facilitate intrusion detection in high speed networks, network-based IPS appliances 80 and 81 preferably include a large capture RAM for capturing packets as the arrive on respective Ethernet networks 55 and 56. Additionally, it is preferable that network-based IPS appliances 80 and 81 respectively include hardware-based filters for filtering network traffic although IPS filtering by network-based IPS appliances 80 and 81 may be implemented in software. Moreover, network-based IPS appliances 80 and 81 may be configured, for example by demand of IPS management node 85, to monitor one or more specific devices rather than all devices on a common network. For example, network-based IPS appliance 80 may be directed to monitor only network data traffic addressed to web server 270A.

Hybrid host-based and node-based intrusion prevention system technologies may be implemented on all nodes 270A-270N on Ethernet networks 55 and 56 that may be targeted by a network attack. In general, each node is comprised of a reprogrammable computer having a central processing unit, a memory module operable to store machine readable code that is retrievable and executable by the CPU and may include various peripheral devices, such as a display monitor, a keyboard, a mouse or another device, connected thereto. A storage media, such as a magnetic disc, an optical disc or another component operable to store data, may be connected to memory module and accessible thereby and may provide one or more databases for archiving local intrusion events and intrusion event reports. An operating system may be loaded into memory module, for example upon bootup of the respective node, and comprises an instance of a network stack as well as various low-level software modules required for tasks such as interfacing to peripheral hardware, scheduling of tasks, allocation of storage as well as other system tasks. Each node protected by the hybrid host-based and node-based IPS of the present invention accordingly has in IPS software application maintained within the node, such as in a magnetic hard disc, that is retrievable by the operating system and executable by the central processing unit. Additionally, each node executing an instance of the IPS application has a local database from which signature descriptions of documented attacks may be fetched from storage and compared with a packet or frame of data to detect a correspondence therebetween. Detection of a correspondence between a packet or frame at an IDS server may result in execution of any one or more of various security procedures.

The IPS described with reference to FIG. 2 may be implemented on any number of platforms. Each hybrid host-based and node-based instance of the IPS application described herein is implemented on a network node, such as web server 270A, operating under control of an operating system such as Windows NT 4.0 that is stored in a main memory and running on a central processing unit and attempts to detect attacks targeted at the hosting node. The particular network 100 illustrated in FIG. 2 is exemplary only and may include any number of network servers. Corporate, and other large scale, networks may typically include numerous individual systems providing similar services. For example, a corporate network may include hundreds of individual web servers, mail servers, FTP servers and other systems providing common data services.

Each operating system of a node incorporating an instance of an IPS application additionally comprises a network stack 90, as illustrated in FIG. 3, that defines the entry point for frames received by a targeted node from the network, e.g. the Internet or Intranet. Network stack 90 illustrated is representative of the well known WindowsNT (TM) system network stack and is so chosen to facilitate discussion and understanding of the invention. However, it should be understood that the invention is not limited to implementation of the illustrated network stack 90 but, rather, stack 90 is described to facilitate understanding of the invention. Network stack 90 comprises a transport driver interface (TDI) 125, a transport driver 130, a protocol driver 135 and a media access control (MAC) driver 145 that interfaces with the physical media 101. Transport driver interface 125 functions to interface the transport driver 130 with higher level file system drivers. Accordingly, TDI 125 enables operating system drivers, such as network redirectors, to activate a session, or bind, with the appropriate protocol driver 135. Accordingly, a redirector can access the appropriate protocol, for example UDP, TCP, NetBEUI or other network or transport layer protocol, thereby making the redirector protocol independent. The protocol driver 135 creates data packets that are sent from the computer hosting the network stack 90 to another computer or device on the network or another network via the physical media 101. Typical protocols supported by an NT network stack include NetBEUI, TCP/IP, NWLink, Data Link Control (DLC) and AppleTalk although other transport and/or network protocols may be included. MAC driver 145, for example an Ethernet driver, a token ring driver or other networking driver, provides appropriate formatting and interfacing with the physical media 101 such as a coaxial cable or another transmission medium.

The capabilities of the host-based IPS include application monitoring of: file system events; registry access; successful security events; failed security events and suspicious process monitoring. Network access applications, such as Microsoft IPS and SQL Server, may also have processes related thereto monitored.

Intrusions may be prevented on a particular IPS host by implementation of inline, node-based monitoring technologies according to an embodiment of the present invention. The inline-IPS is preferably included as part of a hybrid host-based and node-based IPS although it may be implemented independently of any host-based IPS system. The inline-IPS will analyze packets received at the hosting node and perform signature analysis thereof against a database of known signatures by network layer filtering.

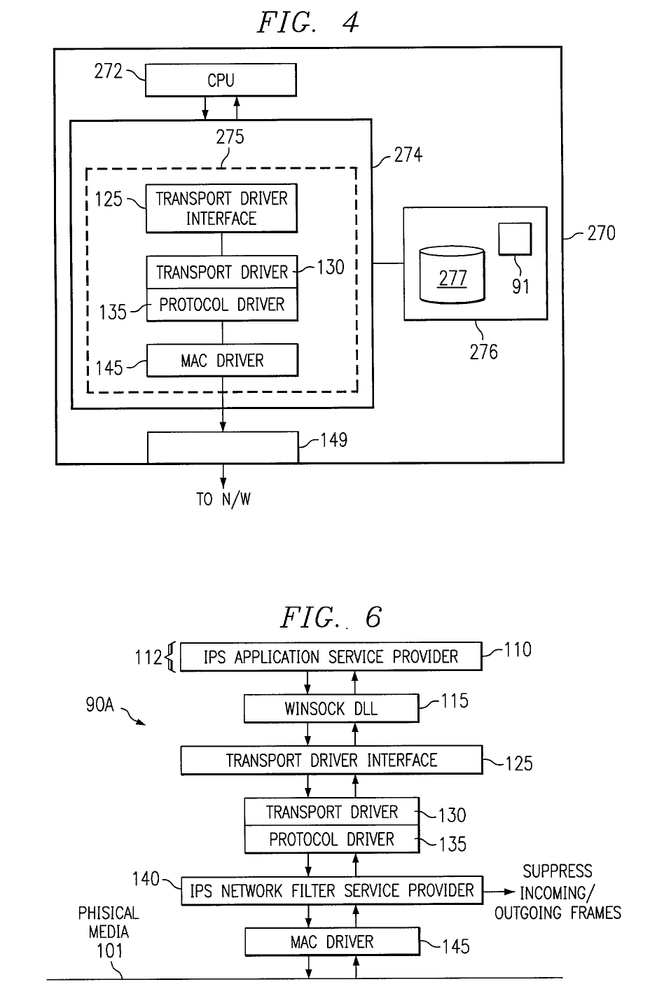

In FIG. 4, there is illustrated a network node 270 that may run an instance of an IPS application 91 and thus operate as an IPS server. IPS application 91 may be implemented as a three-layered IPS, as described in co-pending application entitled “Method and Computer Readable Medium for a Three-Layered Intrusion Prevention System for Detecting Network Exploits” and filed concurrently herewith, and may comprise a server application and/or a client application. Network node 270, in general, comprises a central processing unit (CPU) 272 and a memory module 274 operable to store machine readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 270, and comprises an instance of network stack 90 and may have an intrusion prevention system application 91 loaded from storage media 276. One or more network exploit rules, an exemplary form described in co-pending application entitled “Method, Node and Computer Readable Medium for Identifying Data in a Network Exploit” and filed concurrently herewith, may be compiled into a machine-readable signature(s) and stored within a database 277 that is loadable into memory module 274 and may be retrieved by IPS application 91 for facilitating analysis of network frames and/or packets.

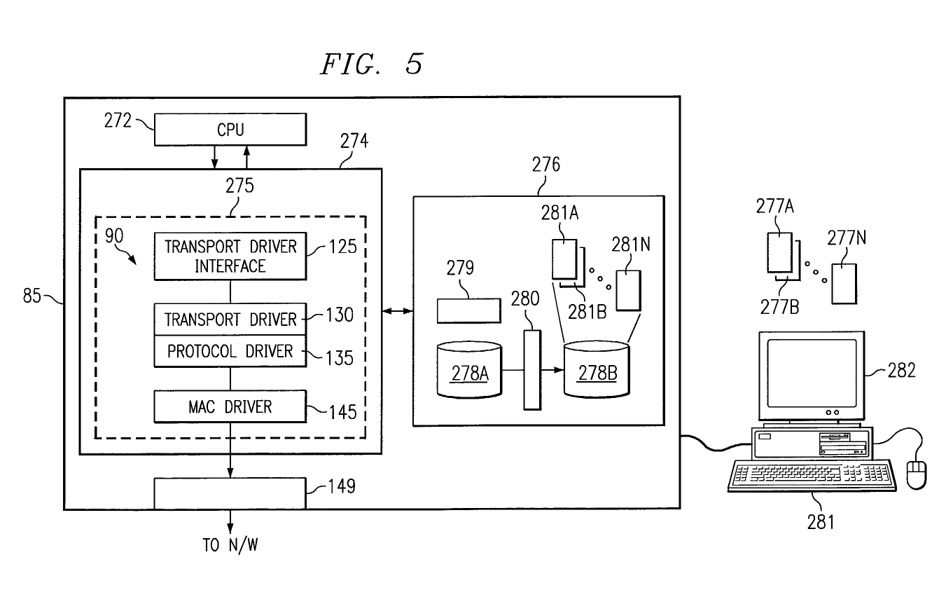

In FIG. 5, there is illustrated an exemplary network node that may operate as a management node 85 of the IPS of a network 100. Management node 85, in general, comprises a CPU 272 and a memory module 274 operable to store machine readable code that is retrievable and executable by CPU 272 via a bus (not shown). A storage media 276, such as a magnetic disc, an optical disc or another component operable to store data, may be connected to memory module 274 and accessible thereby by the bus as well. An operating system 275 may be loaded into memory module 274, for example upon bootup of node 85, and comprises an instance of network stack 90. Operating system 275 is operable to fetch an IPS management application 279 from storage media 276 and load management application 279 into memory module 274 where it may be executed by CPU 272. Node 85 preferably has an input device 281, such as a keyboard, and an output device 282, such as a monitor, connected thereto.

An operator of management node 85 may input one or more text-files 277A-277N via input device 281. Each text-file 277A-277N may define a network-based exploit and include a logical description of an attack signature as well as IPS directives to execute upon an IPS evaluation of an intrusion-related event associated with the described attack signature. Each text file 277A-277N may be stored in a database 278A on storage media 276 and compiled by a compiler 280 into a respective machine-readable signature file 281A-281N that is stored in a database 278B. Each of the machine-readable signature files 281A-281N comprises binary logic representative of the attack signature as described in the respectively associated text-file 277A-277N. An operator of management node 85 may periodically direct management node, through interaction with a client application of IPS application 279 via input device 281, to transmit one or more machine-readable signature files (also generally referred to herein as “signature files”) stored in database 278B to a node, or a plurality of nodes, in network 100. Alternatively, signature files 281A-281N may be stored on a computer readable medium, such as a compact disk, magnetic floppy disk or another portable storage device, and installed on node 270 of network 100. Application 279 is preferably operable to transmit all such signature-files 281A-281N, or one or more subsets thereof, to a node, or a plurality of nodes, in network 100. Preferably, IPS application 279 provides a graphical user interface on output device 282 for facilitating input of commands thereto by an operator of node 85.

As mentioned hereinabove, an IPS application is often susceptible to a polymorphic attack. IPSs identify hostile packets based upon a predefined signature and due to the fact that the predefined signature is associated with an undesirable effect, such as loss of computational facilities, granting of unauthorized access or other objectionable system behavior, polymorphic attacks may be seen as essentially altering the IPS perception of the targeted system's response to data collected by the PS from the network stack of the target node. When an IPS application 91 is implemented in a network-based IPS appliance, passive monitoring is typically employed as the network-based IPS appliance does not generally disable network access in the event of network IPS failure. Thus, targeting a network-based IPS appliance in an attack is often desirable to an attacker—if the network-based IPS appliance can be attacked and disabled, the network security is, at the least, significantly reduced and provides a much more susceptible system for additional attacks.

Polymorphic attacks, including both insertion and evasion attacks, attempt to cause the network IPS's protocol, or signature, analysis component to falsely ascertain the behavioral response of the network stack to data received (inbound or outbound) thereby. An insertion attack generally involves transmitting invalid packets into the network. An evasion attack involves exploiting differences between the signature analysis of the IPS and the functional differences of the targeted system in order to pass packets by the network-based IPS appliance without proper analysis thereof. For example, an IPS will often evaluate the expected response to a particular packet or network frame of a targeted system based on published protocol standards that define specified behavior of a standardized network stack 90. However, in actuality numerous vendors manufacture various operating systems that employ variations of standardized network stack 90 and each system may produce various deviations from published standards. Thus, an IPS application 91 may make a decision regarding treatment of a received packet or network frame based on an expected network stack behavior of the system running IPS application 91. Network stack 90 running on a targeted system, however, may have behavioral deviations that are not evaluated by IPS application 91. The IPS is thus unable to make an accurate decision on the actual behavior of network stack 91 and, thus, attackers may exploit knowledge of the security measures of the IPS based on discrepancies between the IPS's expected behavior of network stack 90 and the actual behavior thereof.

In FIG. 6, there is illustrated an exemplary network stack 90A having an Intrusion protection system inserted therein for preventing polymorphic attacks according to an embodiment of the invention. Network stack 90A comprises TDI 125, a transport driver 130, a protocol driver 135 and a media access control (MAC) driver 145 that interfaces with the physical media 101. Transport driver interface 125 functions to interface the transport driver 130 with higher level file system drivers and enables operating system drivers to bind with an appropriate protocol driver 135. Protocol driver 135 creates data packets that are sent from the computer hosting network stack 90A to another computer or device on the network or another network via physical media 101. MAC driver 145, for example an Ethernet driver, a token ring driver or another networking driver, provides appropriate formatting and interfacing with the physical media 101 such as a coaxial cable, copper pair or other transmission medium. Network stack 90A additionally may comprise a dynamically linked library 115 that allows a plurality of subroutines to be accessed by applications 110 at application layer 112 of stack 90A and facilitates linking with other applications thereby. Dynamically linked library 115 may alternatively be excluded and the functionality thereof may be incorporated into the operating system kernel.

An intrusion prevention system network filter service provider 140, implemented as an intermediate driver, is installed above the physical media driver 145, such as an Ethernet driver, token ring driver, etc., and bound thereto. Intrusion prevention system network filter service provider 140 is preferably bound to protocol driver 135 as well and, accordingly, all machine-readable signature files maintained in database 277 may be validated against incoming and outgoing frames thereby. Intrusion prevention system network filter service provider 140 preferably binds to both media access control driver 145 and protocol driver 135 at system initialization, or boot, of the operating system of the node hosting IPS filter service provider 140. IPS network filter service provider 140 provides low level filtering to facilitate suppression of network attacks including “atomic” network attacks, network protocol level attacks, IP port filtering and also serves to facilitate collection of network statistics. Accordingly, by implementing a filter service provider 140 of the IPS at the network layer of network stack 90A, the IPS observes and analyzes identical data that the network stack processes. Accordingly, filter service provider 140 may evaluate execution of IPS services based on processing behavior of network stack 90A.

What is claimed:

1. A node of a network running an intrusion detection system, the node comprising:
a central processing unit;
a memory module for storing data in machine readable format for retrieval and execution by the central processing unit;
a database for storing a plurality of machine-readable network-exploit signatures;
an operating system comprising a network stack comprising a protocol driver, a media access control driver and an instance of the intrusion detection system implemented as an intermediate driver and bound to the protocol driver and the media access control driver.

2. The node according to claim 1, wherein a frame received on a network medium connected to the node is processed by the media access control driver, the intrusion detection system receiving the processed frame directly from the media access control driver.

3. The node according to claim 2, wherein the intrusion detection system receiving the processed frame is operable to pass the processed frame to the protocol driver.

4. The node according to claim 2, wherein the intrusion detection system receiving the processed frame discards the processed frame.

5. The node according to claim 1, wherein a datagram generated by the node is received by the intrusion detection system.

6. The node according to claim 5, wherein the intrusion detection system is operable to pass the datagram to the media access control driver.

7. The node according to claim 5, wherein the intrusion detection system is operable to discard the datagram.

8. A method of performing intrusion prevention at a node of a network, comprising:
binding a network filter service provider to a media access control driver of a network stack of the node; and
binding the network filter service provider to a protocol driver a the network stack of the node.

10. The method according to claim 8, further comprising filtering, by the network filter service provider, all data received by the media access control driver prior to passing of the data to the protocol driver.

11. The method according to claim 8, further comprising filtering, by the network filter service provider, all data received by the protocol driver prior to passing of the data to the media access control driver.

12. A computer-readable medium having stored thereon a set of instructions to be executed, the set of instructions, when executed by a processor, cause the processor to perform a computer method of:
binding a network filter service provider with a media access control driver of a network stack of an operating system; and
binding the network filter service provider with a protocol driver of the network stack of the operating system.

13. The computer readable medium according to claim 12 wherein binding the network filter service provider to the media access control driver and to the protocol driver occurs upon initialization of the operating system.
